(19) United States
(12) Patent Application Publication
(10) Pub. No.: US 2003/0115672 A1
(43) Pub. Date: Jun. 26, 2003

(54) Dual patient support control system

(76) Inventor: David C. Newkirk, Lawrenceburg, IN (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/318,797

(22) Filed: Dec. 13, 2002

Related U.S. Application Data
(60) Provisional application No. 60/344,924, filed on Dec. 21, 2001.

(51) Int. Cl. A61G 7/05; A61G 7/015

(52) U.S. Cl. 5/600; 5/617

(57) ABSTRACT

A medical device control system and related method for simultaneously controlling operation of first and second patient supports.

### CROSS-REFERENCE TO RELATED APPLICATION

This application claims the benefit of U.S. Provisional Application Serial No. 60/344,924, filed Dec. 21, 2001, the disclosure of which is expressly incorporated by reference herein.

### BACKGROUND AND SUMMARY OF THE INVENTION

The present invention relates generally to device control systems and, more particularly, to control systems providing for the operation of multiple pieces of medical equipment. Moreover, the present invention relates to a method and apparatus for simultaneously controlling a pair of patient supports arranged in a longitudinally adjacent, or side-by-side, relationship.

Many medical devices, such as patient supports including adjustable support surfaces, are controllable by manipulating a device controller. More particularly, conventional patient supports include articulated support surfaces operably connected to motors which adjust the support surfaces to a plurality of desired configurations. Other examples of controllable medical devices having adjustable support surfaces include mattresses with multiple pressure adjustable fluid chambers, including mattresses with vacuum beads for conforming the mattress surface to a patient.

Conventional patient supports have a support surface with a length and a width defined to provide adequate support for a majority of patients. However, certain patients require a support surface having a width greater than that commonly provided by traditional patient supports. More particularly, morbidly obese patients often require a support surface wider than that offered by a single patient support. In such instances, it is commonly known to place a pair of patient supports longitudinally adjacent, or side-by-side, such that the patient is supported by both patient supports.

The conventional practice of placing a pair of patient supports in such a side-by-side relationship presents certain operational difficulties. More particularly, each patient support typically includes a separate controller which must be manipulated in order to adjust its respective support surface to a desired configuration. As such, the operator must often simultaneously manipulate two separate controllers. Further, the operator must manually attempt to synchronize the motion of both patient supports to provide a substantially uniform support surface for the patient as the individual support surfaces of both patient supports move into the desired configurations.

According to the present invention, a medical device control system for simultaneously controlling a first patient support and a second patient support is provided. The first patient support includes a controllable first articulated frame and the second patient support includes a controllable second articulated frame. The medical device control system includes a user input device configured to generate an input signal in response to activation by a user. A processor is provided in communication with the user input device and is configured to generate a control signal in response to the input signal. A multiple unit control device is provided in communication with the processor and is configured to simultaneously drive the first and second articulated frames through first and second paths of travel to first and second desired frame configurations, respectively, in response to the control signal. The multiple unit control device illustratively includes a synchronization device configured to synchronize movement of the first and second articulated frames such that the first desired frame configuration is substantially the same as the second desired frame configuration. Moreover, the synchronization device maintains substantial equivalence between the configurations of the first and second articulated frames through the first and second paths of travel.

In illustrative embodiments, the first and second patient supports include position sensors configured to detect the frame configurations of the first and second articulated frames and configured to generate position signals indicative thereof. The multiple unit control device is configured to receive the position signals from the position sensors of the first and second patient supports, respectively.

In a further illustrative embodiment, a medical device control system is provided for controlling a first patient support having a controllable first articulated frame and a second patient support having a controllable second articulated frame. The medical device control system includes a housing, and a frame control input device coupled to the housing. The frame control input device is configured to generate an input signal in response to activation by a user. A selector is coupled to the input device and is configured to be placed in any one of at least three modes of operation. A first mode of operation places the input device in communication with the first patient support, while a second mode of operation places the input device in communication with the second patient support. A third mode of operation places the input device in communication with both the first patient support and the second patient support.

Illustratively, the selector is further configured to be placed in a fourth mode of operation which disconnects the input device from both the first and second patient supports. The selector illustratively comprises a push button switch supported by the housing and configured to sequence through at least three conditions representing the at least three modes of operation. In a further illustrative embodiment, the selector comprises a rotary switch supported by the housing for rotation between at least three positions representing the at least three modes of operation.

In another illustrative embodiment, a patient support apparatus of the present invention includes a first patient support including a first frame having a plurality of first frame sections movable relative to each other to position the first frame in a plurality of different frame configurations. The patient support apparatus further comprises a second patient support including a second frame having a plurality of second frame sections movable relative to each other to position the second frame in a plurality of different frame configurations, the second frame being positioned longitudinally adjacent to the first frame. A first frame drive mechanism is configured to drive the first frame in motion, while a second frame drive mechanism is configured to drive the second frame in motion. A controller is coupled to both the first patient support and the second patient support for activating simultaneously both the first frame drive mechanism and the second frame drive mechanism.

Illustratively, the controller includes a multiple unit control device configured to simultaneously drive the first and second articulated frames through first and second paths of travel to first and second desired frame configurations. The multiple unit control device illustratively includes a synchronization device configured to synchronize movement of the first and second articulated frames such that the first desired frame configuration is substantially the same as the second desired frame configuration. Moreover, the synchronization device maintains substantial equivalence between the configurations of the first and second articulated frames through the first and second paths of travel.

Further, the first and second patient supports illustratively include position sensors configured to detect the frame configurations of the first and second articulated frames and configured to generate position signals indicative thereof. The multiple unit control device is configured to receive the first and second position signals from the position sensors of the first and second patient supports.

According to other aspects of the invention, the patient support apparatus further comprises a first mattress having a first patient support surface coupled to the first frame and a second mattress having a second patient support surface coupled to the second frame, the multiple unit control device being configured to simultaneously adjust the first and second patient support surfaces to first and second desired surface configurations. Illustratively, the first and second mattresses each comprise a plurality of inflatable fluid chambers.

In a further illustrative embodiment of the invention, a patient support system includes a first articulated frame defining a first longitudinal axis, and a second articulated frame defining a second longitudinal axis extending substantially parallel to the first longitudinal axis. The second articulated frame is configured for articulating movement independently from the first articulated frame. A first frame drive is operably coupled to the first articulated frame and is configured to drive the first articulated frame in motion. A second frame drive is operably coupled to the second articulated frame and is configured to drive the second articulated frame in motion. A user input device is operably connected to the first and second frame drives. A multiple unit control device is provided in communication with the user input device for controlling simultaneous movement of the first and second articulated frames through first and second paths of travel to first and second desired frame configurations, respectively. The multiple unit control device illustratively includes a synchronization device configured to synchronize movement of the first and second articulated frames such that the configurations of the first and second articulated frames are maintained substantially the same throughout the first and second paths of travel.

Illustratively, first and second position sensors are operably coupled to the first and second articulated frames and are configured to detect the frame configurations of the first and second articulated frames and generate position signals indicative thereof. The multiple unit control device is configured to receive the position signals from the first and second position sensors.

According to other aspects of the invention, the patient support apparatus further comprises a first mattress having a first patient support surface coupled to the first articulated frame and a second mattress having a second patient support surface coupled to the second articulated frame, wherein the multiple unit control device is configured to simultaneously adjust the first and second patient support surfaces to first and second desired surface configurations. Illustratively, the first and second mattresses each comprise a plurality of inflatable fluid chambers.

According to a further illustrative embodiment of the invention, a patient support system is provided including a first articulated frame defining a first longitudinal axis and a second articulated frame defining a second longitudinal axis extending substantially parallel to the first longitudinal axis. The second articulated frame is configured for articulating movement independently from the first articulated frame. A first frame drive is operably coupled to the first articulated frame and is configured to drive the first articulated frame in motion. A second frame drive is coupled to the second articulated frame and is configured to drive the second articulated frame in motion. A frame control input device is operably coupled to the first and second frame drives and is configured to generate an input signal. A selector is provided in communication with the frame control input device and is configured to be placed in any one of at least three modes of operation. A first mode of operation places the input device in communication with the first frame drive, while a second mode of operation places the input device in communication with the second frame drive. A third mode of operation places the input device in communication with both the first frame drive and the second frame drive.

Illustratively, the patient support system further comprises a processor in communication with the frame control input device for generating a control signal in response to the input signal. The selector is further configured to be placed in a fourth mode of operation which disconnects the input device from both the first and second frame drives.

The present invention further provides a method of moving first and second patient supports in substantially synchronized motion, the method comprising the step of providing a first patient support including a first articulated frame, the first articulated frame including a plurality of movable sections and defining a first longitudinal axis. The method further comprises the step of providing a second patient support including a second articulated frame, the second articulated frame including a plurality of movable sections and defining a second longitudinal axis. The method further comprises the steps of placing the first patient support and the second patient support proximate each other such that the first longitudinal axis is substantially parallel to the second longitudinal axis, and simultaneously driving in motion both the first articulated frame and the second articulated frame through first and second paths of travel to first and second desired frame configurations. The method also includes the step of synchronizing movement of the first and second articulated frames through the first and second paths of travel such that the first desired frame configuration is substantially the same as the second desired frame configuration.

Illustratively, the step of synchronizing movement comprises the steps of providing first and second position information from the first and second patient supports indicative of the positioning of the plurality of movable sections of the first and second frames, comparing the first position information with the second position information, and adjusting the position of at least one movable section of one of the first and second frames relative to a corresponding movable section of the other of the second and first frames in response to the first and second position information. The step of comparing the first position information with the second position information comprises the step of designating one of the first and second frames as a lagging frame and the other of the first and second frames as an advancing frame.

Illustratively, the step of adjusting the relative positioning comprises the step of increasing the speed of the lagging frame. Alternatively, the step of adjusting the relative positioning comprises the step of decreasing the speed of the advancing frame.

Additional features and advantages of the present invention will become apparent to those skilled in the art upon consideration of the following detailed description of the presently perceived best mode of carrying out the invention.

### BRIEF DESCRIPTION OF THE DRAWINGS

The detailed description of the drawings particularly refers to the accompanying figures in which:

FIG. 1 is a perspective view of first and second patient supports positioned in initial frame configurations and arranged in a longitudinally adjacent relationship, and a single medical device control pendant coupled to both the first and second patient supports;

FIG. 2 is a perspective view similar to FIG. 1 illustrating the first and second patient supports positioned in desired frame configurations;

FIG. 3 is a front elevational view of an illustrative control pendant of the present invention;

FIG. 4 is a block diagram showing the architecture of a first illustrative patient support system of the present invention;

FIG. 5 is a block diagram showing the architecture of a second illustrative patient support system of the present invention;

FIG. 6 is a block diagram showing the architecture of a third illustrative patient support system of the present invention;

FIG. 7 is a block diagram showing the architecture of a fourth illustrative patient support system of the present invention;

FIG. 8 is a front elevational view of a further illustrative control pendant of the present invention;

FIG. 9 is a detailed view of FIG. 8 illustrating a selector of the illustrative control pendant;

FIG. 10 is a detailed view similar to FIG. 9 illustrating an alternative embodiment selector;

FIG. 11 is a block diagram showing the architecture of a fifth illustrative patient support system of the present invention;

FIG. 12 is a flow chart showing a first illustrative method of operation of the present invention; and

FIG. 13 is a flow chart showing a second illustrative method of operation of the present invention.

### DETAILED DESCRIPTION OF THE DRAWINGS

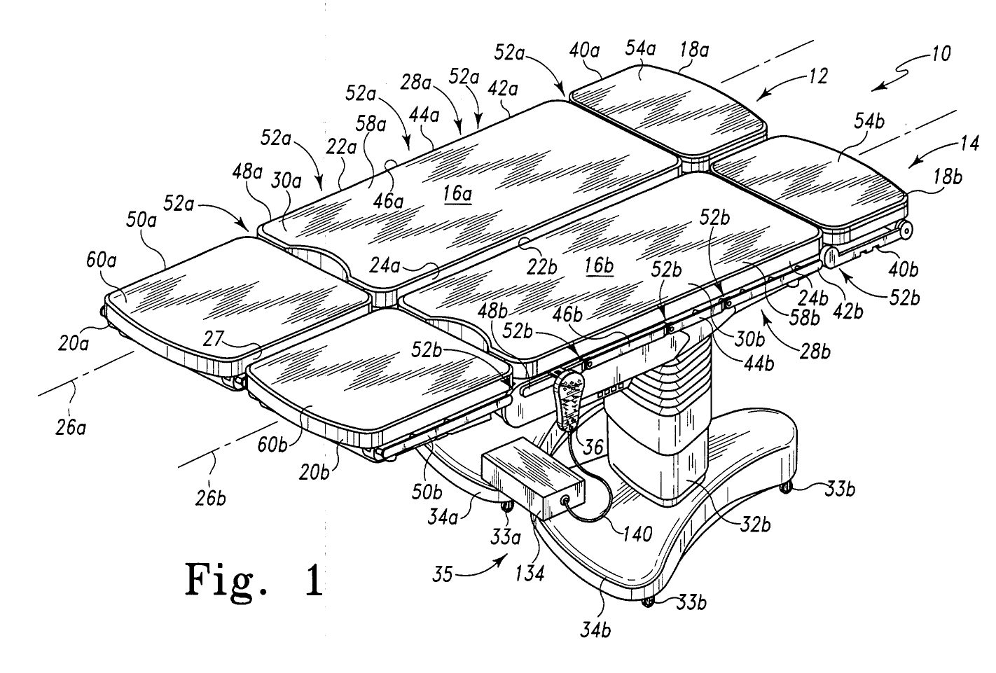

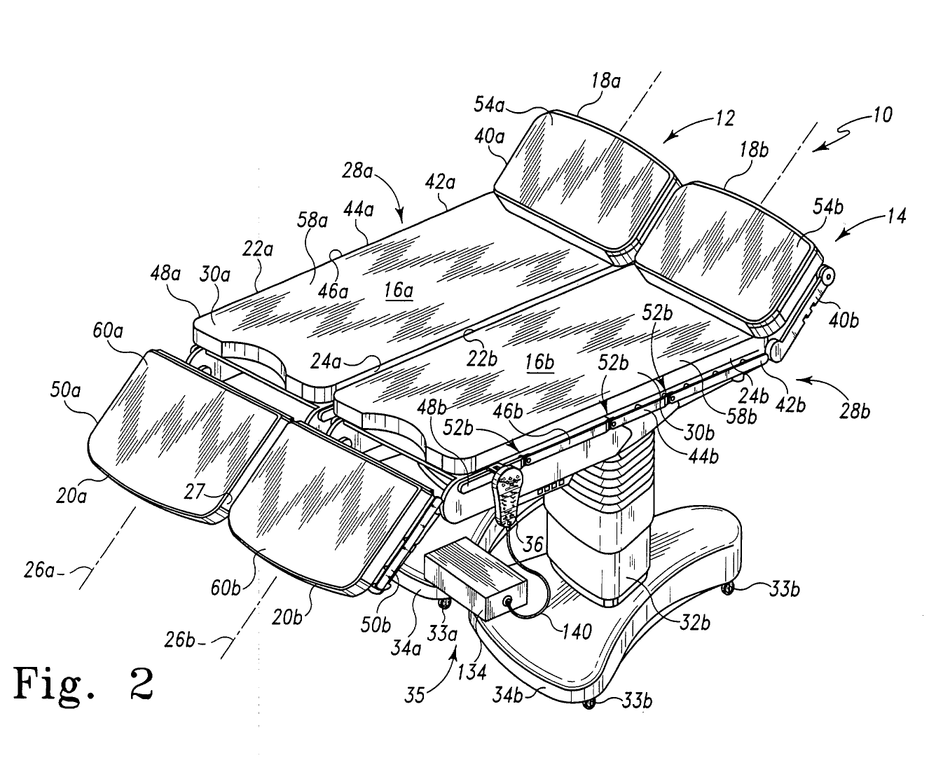

A patient support apparatus or system 10 according to the present invention is illustrated in FIGS. 1 and 2 as including a first patient support or table 12 positioned longitudinally adjacent a second patient support or table 14. It should be noted that the structural details of the first patient support 12 may be substantially identical to those of the second patient support 14. As such, in the following description, identical components of the first patient support 12 and the second patient support 14 will be identified with identical reference numerals followed by the reference letter “a” to designate the first patient support 12 and the reference letter “b” to designate the second patient support 14.

While in the drawing figures the patient supports 12 and 14 are illustrated as surgical or operating room tables, it should be appreciated that the present invention finds equal applicability with other patient supports, including hospital beds.

The first table 12 and the second table 14 each define a patient support surface 16a, 16b extending longitudinally between opposing ends 18a, 18b and 20a, 20b and laterally between longitudinally extending side edges 22a, 22b and 24a, 24b. Furthermore, each support surface 16a, 16b defines a longitudinally extending center axis 26a, 26b.

As illustrated in FIG. 1, the first table 12 and the second table 14 are positioned such that their respective longitudinal axes 26a and 26b are substantially parallel to each other. Moreover, the right side edge 24a of the first table 12 is disposed immediately adjacent to the left side edge 22b of the second table 14. As such, the patient support surfaces 16a and 16b of the first table 12 and the second table 14 effectively define a single patient support surface. A small clearance gap 27 extends between the support surfaces 16a and 16b which may be covered by a flexible or resilient pad (not shown) as desired for additional patient comfort.

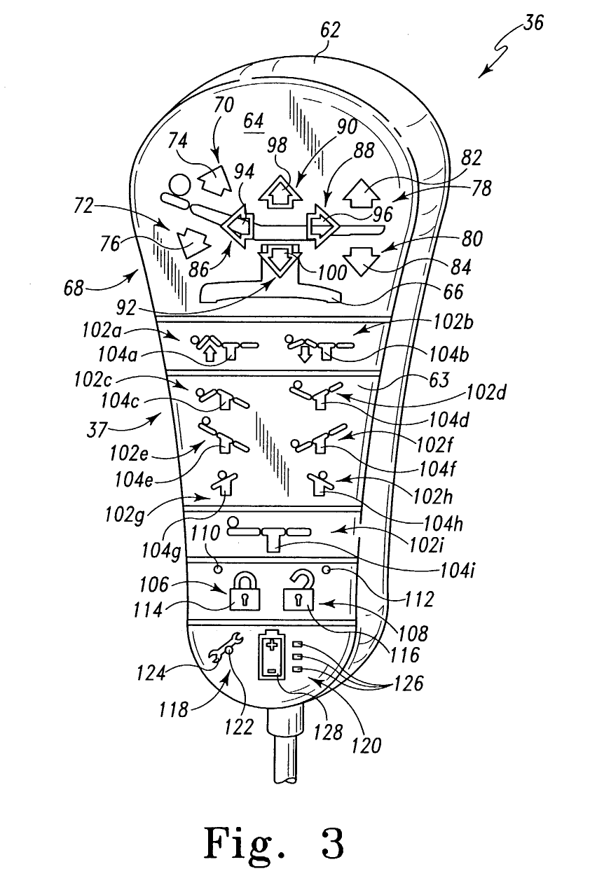

The first and second tables 12 and 14 may be of conventional design and of the type which provide a variety of controllable functions. Each table 12 and 14 includes an articulated table frame 28a, 28b, a mattress 30a, 30b, and a vertical support column 32a, 32b. A plurality of casters 33a, 33b support a base 34a, 34b which, in turn, supports the column 32a, 32b. A control system 35 is coupled to both of the tables 12 and 14 of the present invention and illustratively includes a single control pendant 36. The pendant 36 may include a plurality of buttons 37 (FIGS. 3 and 8) cooperating with conventional membrane-type switches (not shown). Each table 12 and 14 may also include a foot control panel (not shown) including a plurality of buttons or switches similar to those provided on the control pendant 36. Both the control pendant 36 and the foot control panel may be utilized to adjust the vertical support columns 32a, 32b, mattresses 30a, 30b, and articulated table frames 28a, 28b as detailed below.

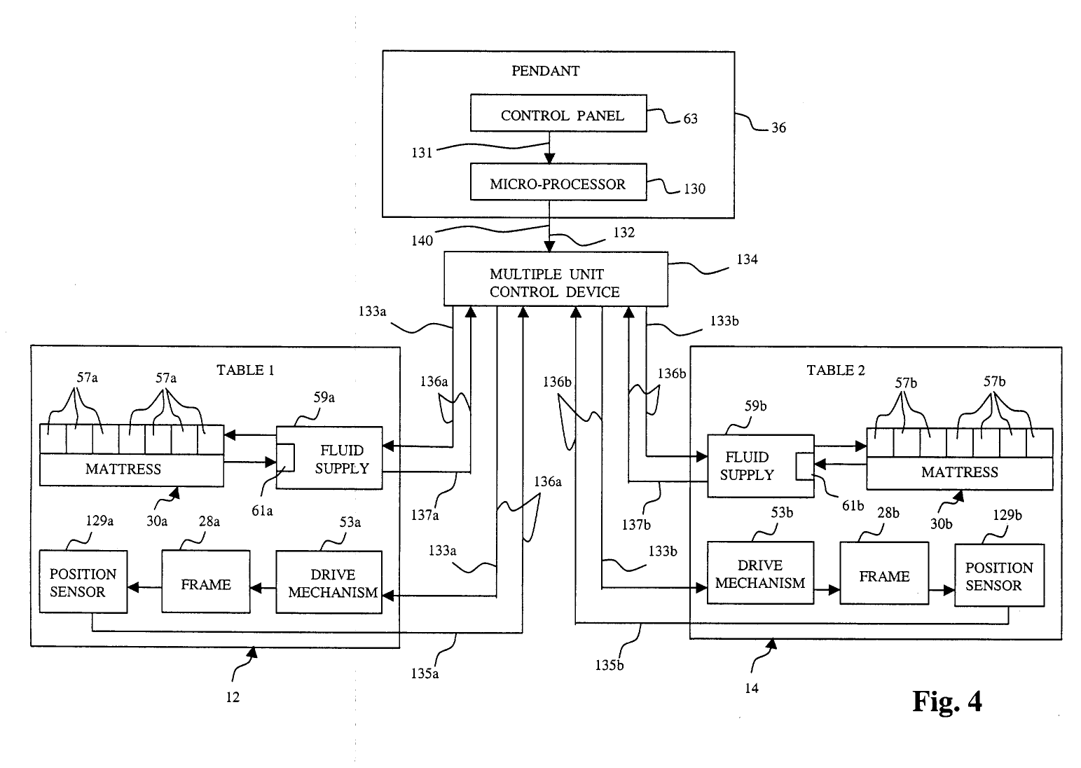

Each articulated table frame 28a, 28b illustratively includes a head section 40a, 40b, an upper back section 42a, 42b, a lower back section 44a, 44b, a seat section 46a, 46b, an upper leg section 48a, 48b, and a lower leg section 50a, 50b. Sections 40, 42, 44, 46, 48, and 50 of each table frame 28a, 28b are coupled to longitudinally adjacent sections via pivots 52a, 52b (FIG. 1) so that adjacent sections can be rotated with respect to each other by a frame drive mechanism 53a, 53b (FIGS. 4-7) including motors or other suitable actuators of the type well known to those skilled in the art. Illustrative table frames 28a, 28b and drive mechanisms 53a, 53b include those disclosed in U.S. Patent Application Serial No. 60/264,090, filed Jan. 25, 2001, U.S. Patent Application Serial No. 60/300,625, filed Jun. 25, 2001, and U.S. Patent Application Serial No. 60/326,866, filed Oct. 3, 2001, all of which are assigned to the assignee of the present invention and are expressly incorporated by reference herein.

Each support column 32a, 32b is similarly vertically adjustable by a lifting mechanism including a conventional motor or actuator (not shown). The lifting mechanism may be of the type disclosed in U.S. Patent Application Serial No. 60/264,214, filed Jan. 25, 2001, which is assigned to the assignee of the present invention and is expressly incorporated by reference herein. The tables 12 and 14 may further include a conventional sliding mechanism (not shown) for moving the seat section 46a, 46b substantially horizontally relative to the respective support column 32a, 32b. Adjustment of the articulated table frame sections 40, 42, 44, 46, 48, and 50 and vertical support columns 32 can be controlled by the buttons 37 disposed on either the control pendant 36 or the foot control panel.

Each mattress 30a, 30b illustratively includes a head section 54a, 54b, a torso section 58a, 58b, and a leg section 60a, 60b. Each torso section 58a, 58b and leg section 60a, 60b illustratively include a plurality of inflatable chambers or bladders 57a, 57b that are individually controllable. Each mattress 30a, 30b may be any type of controllable mattress surface, e.g., some type of fluid mattress such as an air mattress, or a vacuum bead mattress, etc. In the context of the embodiments of the invention as discussed below and as illustrated in FIGS. 4-7, each mattress 30a, 30b illustratively is a vacuum bead air mattress system in which the mattress sections 54a, 54b, 58a, 58b, and 60a, 60b can include multiple chambers 57a, 57b and are coupled to a fluid supply, 59a, 59b, such as a pressure and vacuum system to allow for selectively controlling the amount of pressure or vacuum in any chamber within any of the sections. Each mattress 30a, 30b is illustratively coupled to a plurality of pressure sensors 61a, 61bto allow for measuring pressure within any of the chambers 57a, 57b of the mattress sections 54a, 54b, 58a, 58b and 60a, 60b. The pressure sensors 61a, 61bmay be formed as part of the fluid supply 59a, 59b. An illustrative controllable mattress 30 is disclosed in U.S. Pat. No. 5,966,763, which is assigned to the assignee of the present invention and is expressly incorporated by reference herein. It is understood that any other conventional mattress, surgical surface, or support pad may also be used on the tables 12 and 14.

Further, the mattresses 30a, 30b may be coupled to a heat transfer system for controlling the temperature of the patient support surfaces 16a, 16b. Such a system may comprise that disclosed in U.S. patent application Ser. No. 09/951,577, filed Sep. 11, 2001, which is assigned to the assignee of the present invention and is expressly incorporated by reference herein.

Both patient supports 12 and 14 may be placed into various frame configurations to support a patient for different medical or surgical procedures. For example, FIG. 1 illustrates the tables 12 and 14 in a first substantially horizontal frame configuration, while FIG. 2 illustrates the tables 12 and 14 in a second desired frame configuration. FIG. 2, for illustrative purposes only, shows the head sections 40a, 40b raised relative to the upper back sections 42a, 42b, and the lower leg sections 50a, 50b lowered relative to the upper leg sections 48a, 48b. As discussed in greater detail below, the control system 35 of the present invention provides for automatically and simultaneously placing both tables 12 and 14 in substantially the same desired frame configuration, as well as for incrementally adjusting the table frames 28a, 28b and mattresses 30a, 30b as required to accommodate variations needed for any particular doctor or patient.

Features of controllable patient supports, such as surgical tables 12 and 14, are discussed and shown in detail in U.S. Pat. Nos. 6,073,284; 6,149,674; and 6,202,230; all of which are assigned to the assignee of the present invention and are expressly incorporated by reference herein.

Referring now to FIG. 3, the control pendant 36 may be of a conventional touch pad controller design. The control pendant 36 as illustrated in FIG. 3 includes a housing 62 having a front face 64 supporting a control panel or input device 63. The control panel 63 includes the plurality of buttons 37 for controlling the patient support surfaces 16a and 16b. An iconographic representation 66 of the table frame 30, support column 32 and base 34, is provided on the front face 64 proximate an upper portion 68 of the pendant 36.

A first set of two control buttons 70 and 72 are identified by an upwardly-facing arrow 74 and a downwardly-facing arrow 76, respectively. The control buttons 70 and 72 are disposed adjacent the back section 42 depicted by the iconographic representation 66. As detailed below, the buttons 70 and 72 are operably connected to an actuator of each frame drive mechanism 53a and 53b, such that depressing the button 70 causes the back sections 42 and 44 to move pivotally up relative to the respective seat section 46 and depressing the button 72 causes the back sections 42 and 44 to move pivotally down relative to the respective seat section 46.

A second set of control buttons 78 and 80 are associated with an upwardly-facing arrow 82 and a downwardly-facing arrow 84, respectively. The control buttons 78 and 80 are disposed adjacent the leg section 50 depicted by the iconographic representation 66. The second set of control buttons 78 and 80 are operably connected to an actuator of each frame drive mechanism 53a and 53b, such that depressing the button 78 causes the leg sections 48 and 50 to move pivotally up relative to the respective seat section 46 and depressing the button 80 causes the leg sections 48 and 50 to move pivotally down relative to the respective seat section 46.

A third set of control buttons 86, 88, 90 and 92 are positioned proximate the center of the iconographic table representation 66. Control button 86 is identified by a left-facing arrow 94, while control button 88 is identified by a right-facing arrow 96. Control buttons 86 and 88 are operably connected to the sliding mechanism of each table 12 and 14, wherein depressing the control button 86 moves the seat sections 46 in translational movement toward the respective head section 40 and depressing the control button 88 moves the seat sections 46 in translational movement toward the respective leg sections 48 and 50. Control button 90 is identified with an upwardly facing arrow 98, while control button 92 is identified with a downwardly-facing arrow 100. Control buttons 90 and 92 are operably connected to the lifting mechanism of each table 12 and 14, for moving the support columns 32a and 32b, and hence seat sections 46, in translational movement in a substantially vertical direction upwardly and downwardly, respectively.

Below the iconographic representation 66 are a plurality of preset buttons 102 for causing the sections of the table frames 28a and 28b to move automatically into preset desired frame configurations or positions. Iconographic representations 104 of the table frames 28 in each desired preset position is provided in proximity to, and preferably on the front face 64 of the pendant 36 in overlying relationship to each respective button 102. In the following description, each preset button is identified with reference numeral 102 followed by a letter (i.e., 102a, 102b, . . . ), and is associated with an iconographic representation identified with reference numeral 104 followed by a corresponding letter (i.e., 104a, 104b, . . . ).

Referring further to FIG. 3, a kidney lift position button 102a is provided to the left of a kidney lower position button 102b. The kidney position buttons 102a and 102b control an actuator of each frame drive mechanism 53a and 53b for moving the upper back and lower back sections 42 and 44 in a manner for elevating or lowering the kidneys of a patient supported on the table frames 28a and 28b. Immediately below the kidney position buttons 102a and 102b are flex and reflex buttons 102c and 102d for controlling actuators of each frame drive mechanism 53a and 53b which position the sections of the table frames 28a and 28b in either a downwardly-facing “V” configuration, or an upwardly-facing “V” configuration, respectively. Immediately below the flex and reflex buttons 102c and 102d are provided Trendelenburg and reverse Trendelenburg buttons 102e and 102f. The Trendelenburg and reverse Trendelenburg buttons 102e and 102f are each operably connected to an actuator of each frame drive mechanism 53a and 53b for placing the table frames 28a and 28b in Trendelenburg and reversed Trendelenburg positions, respectively.

Left and right tilt buttons 102g and 102h are provided below the Trendelenburg and reverse Trendelenburg buttons 102e and 102f and control an actuator of each frame drive mechanism 53a and 53b which tilts the table frames 28a and 28b about their longitudinal axes 26a and 26b to the left or right, respectively. A “return to level” button 102i is positioned at the lower level of the plurality of preset buttons 102 and is operable to initiate movement of all of the sections of the table frames 28a and 28b to a horizontal position.

Below the plurality of present buttons 102, a floor lock button 106 and floor unlock button 108 are provided for locking and unlocking the casters 33a and 33b supporting the bases 34a and 34b. Lock and unlock indicators 110 and 112, preferably light emitting diodes (LEDs), are provided immediately adjacent to each of the floor lock and floor unlock buttons 106 and 108, respectively. Again, iconographic representations 114 and 116 of locking and unlocking of the casters 33 are disposed in overlaying relationship to each of the floor unlock and floor lock buttons 106 and 108.

A service indicator 118 and a battery indicator 120 are provided below the floor lock and unlock buttons 106 and 108. The service indicator 118 preferably comprises an LED 122 positioned adjacent an iconographic representation 124 of the need to service the patient support table 12 and 14. The battery indicator 120 includes a plurality of LEDs 126 representing various degrees or remaining battery charges positioned adjacent an iconographic representation 128 of battery charge.

It is understood that other types of controllers may be used to control tables 12 and 14 other than the control pendant 36. For example, the controller disclosed in U.S. Pat. No. 6,351,678, which is assigned to the assignee of the present invention and is expressly incorporated by reference herein, may be used to control the tables 12 and 14.

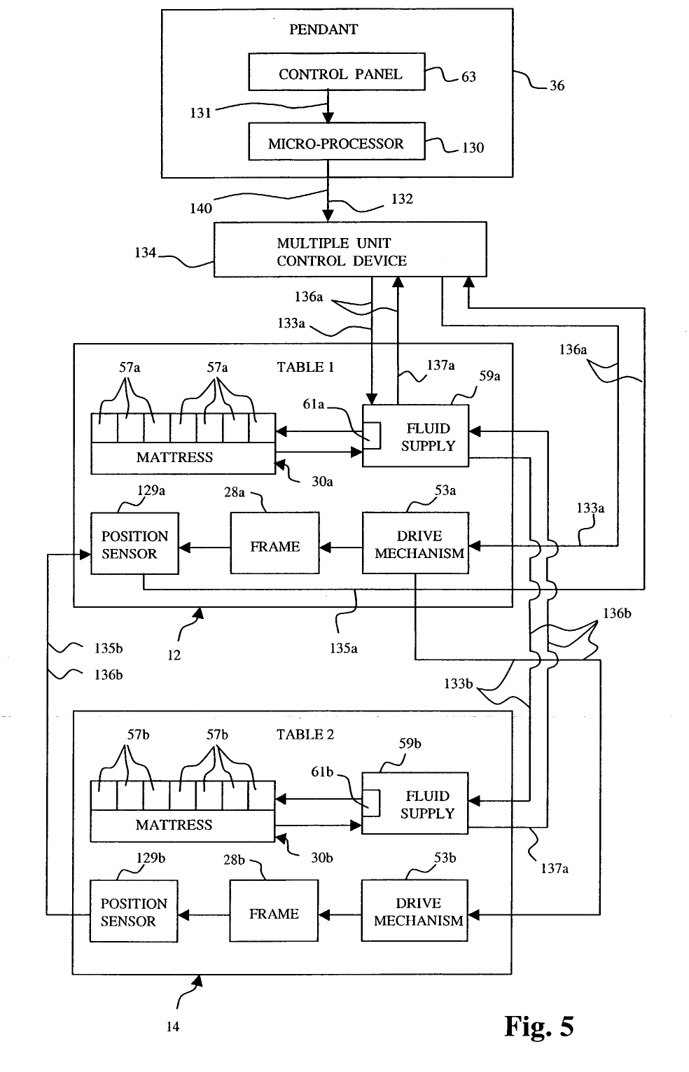

Turning now to FIG. 4, the control pendant 36 illustratively includes a controller or microprocessor 130 programmed to control the tables 12 and 14. The microprocessor 130 is in communication with the input device 63 of the control pendant 36 and is adapted to receive an input signal 131 generated therefrom. The microprocessor (or other controller) 130 may be of conventional design and generates a control signal 132 in response to the input signal 131. A multiple unit control device 134 is adapted to receive the control signal 132 from the microprocessor 130 and generate actuation signals 133a, 133b in response thereto. The multiple unit control device 134 is in communication with both the first table 12 and the second table 14 for transmitting the actuation signals 133a, 133b to both tables 12 and 14. More particularly, the activation signals 133a, 133b may be transmitted to the fluid supplies 59a, 59b in order to control the mattresses 30a, 30b and to the drive mechanisms 53a, 53b to control the frames 28a, 28b. As illustrated in FIG. 4, the multiple unit control device 134 may be arranged or coupled in parallel with the first and second tables 12 and 14. Alternatively, as illustrated in FIG. 5, the multiple unit control device 134 may be arranged or coupled in series with the first and second tables 12 and 14.

Illustratively, position sensors 129a, 129b are operably coupled to the frames 28a, 28b of both tables 12 and 14 to provide feedback position signals 135a, 135b to the multiple unit control device 134. More particularly, the position signals 135a, 135b provide an indication to the multiple unit control device 134 of the relative positioning of each section 40, 42, 44, 46, 48, and 50 of the frames 28a, 28b. The position sensors 129a, 129b may be attached to the frames 28a and 28b themselves, or coupled to the actuators of the drive mechanisms 53a, 53b which drive the frames 28a and 28b in motion. However, it should be appreciated that any conventional position sensor and mounting configuration may be utilized.

Likewise, the pressure sensors 61a, 61bmay transmit pressure signals 137a, 137b to the multiple unit control device 134. The pressure signals 137a, 137b provide an indication to the multiple unit control device 134 of the pressure within the chambers 57a, 57b of the mattresses 30a, 30b.

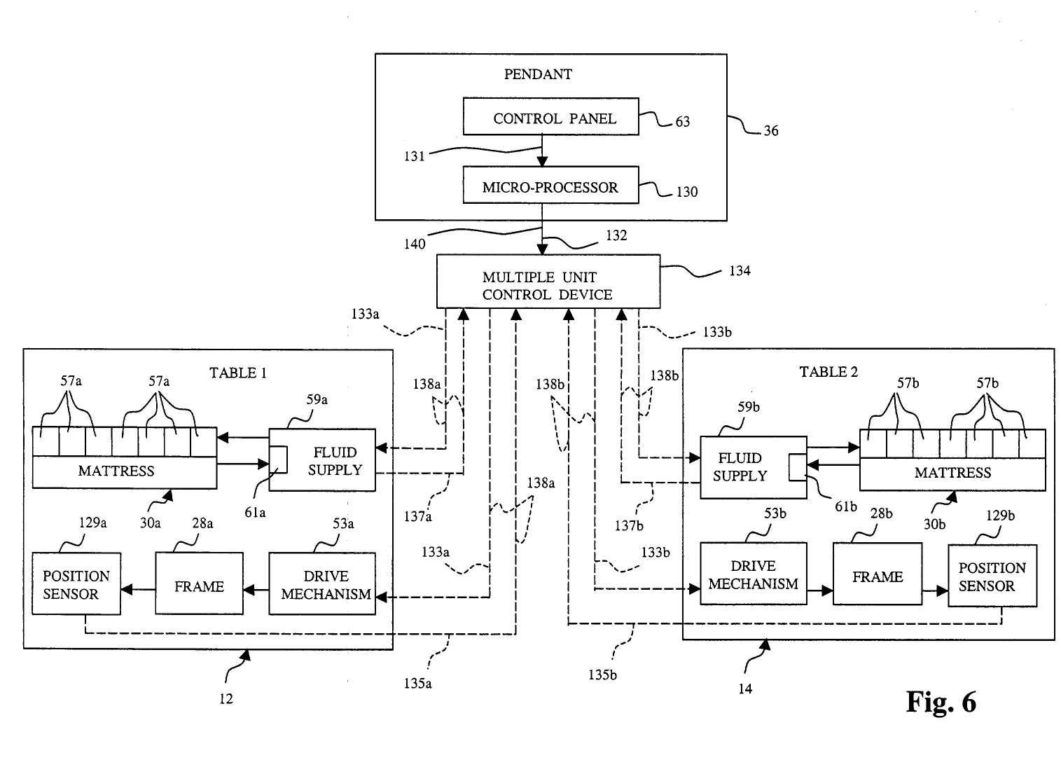

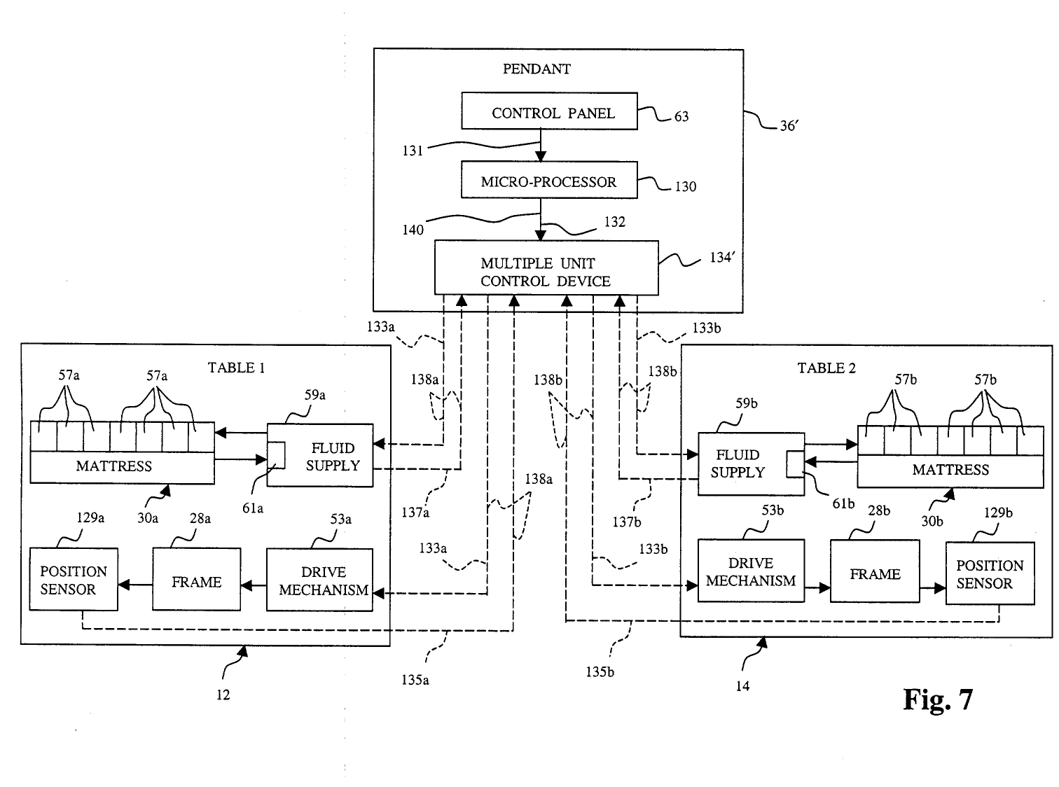

The control device 134 may be wired directly to the first and second tables 12 and 14 using conventional multiple unit wires or cables 136a and 136b as illustrated in FIGS. 4 and 5. Alternatively, the multiple unit control device 134 may use wireless links 138a and 138b, such as a radio frequency (RF) or infrared (IR), to communicate with the first and second tables 12 and 14, as illustrated in FIGS. 6 and 7. Thus, it is within the scope of the present invention for the multiple unit control device 134 to use any means known to those skilled in the art to send signals to the first and second tables 12 and 14. Likewise, the microprocessor 130 may be either directly linked through a cable 140 to the multiple unit control device 134 or may use a wireless link similar to that identified above with respect to the multiple control unit 134 and the tables 12 and 14.

The multiple unit control device 134 of FIGS. 4-6 comprises a unit positioned in spaced relation to the control pendant 36. An alternative embodiment is illustrated in FIG. 7 wherein the multiple unit control device 134′, along with the microprocessor 130, are disposed within the housing 62 of the control pendant 36′. As such, the need for a separate device for attachment intermediate the tables 12 and 14 and the pendant 36 is eliminated.

Referring now to FIGS. 8-10, in a further illustrative embodiment of the present invention, a selector 144 is supported by the control panel 63′ of the control pendant 36″ and is configured to be placed in one of a plurality of modes of operation. As illustrated, the selector 144 may comprise a conventional pushbutton 145 cooperating with a conventional membrane-type switch and which sequences or “toggles” through plurality of different modes of operation. Each depression of the button 145 causes the microprocessor 130 to advance sequentially through the different modes of operation. As illustrated in FIG. 10, the selector 144 may alternatively comprise a conventional rotary switch 145′ supported by the control panel 63′ for rotation, as represented by arrow 149, between the plurality of positions representing the plurality of modes of operation. It should be appreciated that the selector 144 may comprise any conventional switching device.

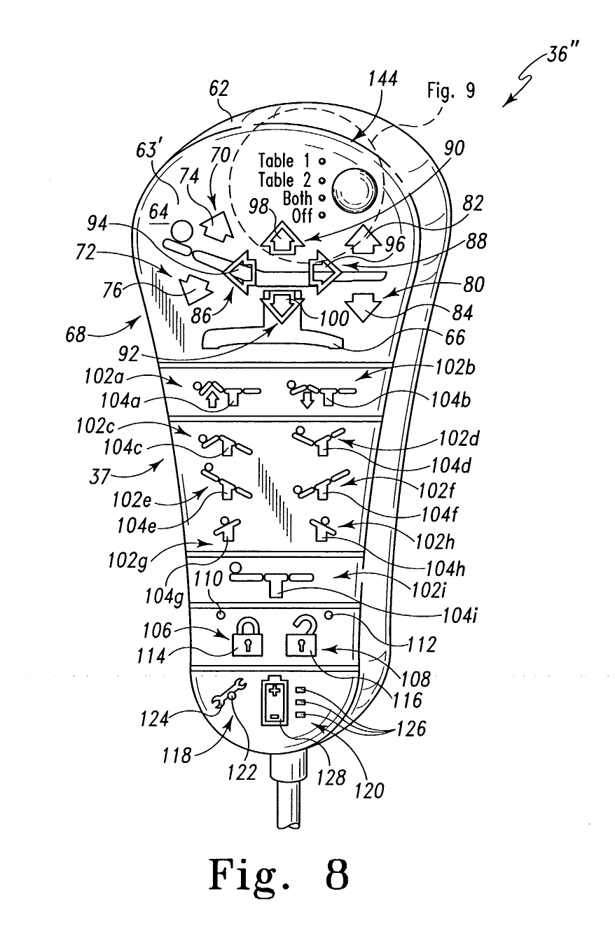

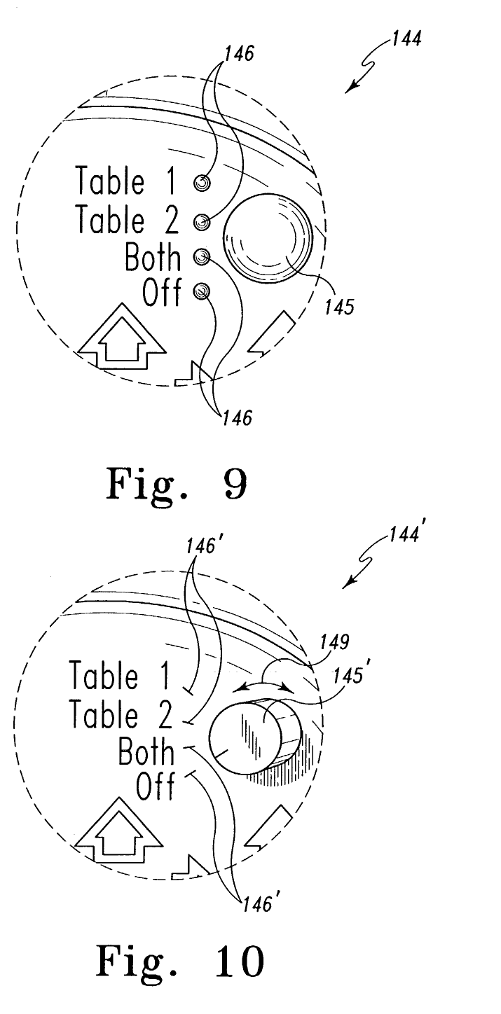

Illustratively, the first mode of operation places the control panel 63′ in communication with the first table 12, while the second mode of operation places the control panel 63′ in communication with the second table 14. In a third mode of operation, the control panel 63′ is placed in communication with both the first table 12 and the second table 14. The selector 144 may further define a fourth mode of operation which disconnects the control panel 63′ from both the first and second tables 12 and 14. Indicators 146, such as LEDs illustrated in FIG. 9, may be supported adjacent the pushbutton 145 and provide the user with an indication of the mode of operation selected. Alternatively, indicators 146′ in the form of alignment markings may be provided adjacent the rotary switch 145′ of FIG. 10 to provide an indication of the mode of operation selected.

A remote control device such as disclosed in U.S. patent application Ser. No. 09/848,941, filed May 4, 2001, which is assigned to the assignee of the present invention and is expressly incorporated by reference herein, may also be used to control table 12 and 14. The control device in the '941 application may be programmed to switch between the various modes of operation described herein.

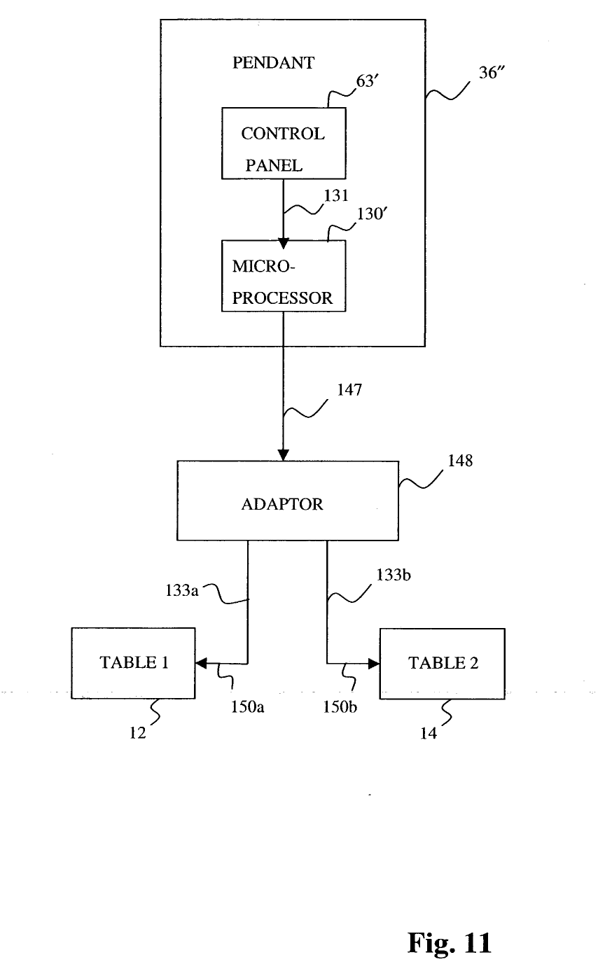

Turning now to FIG. 11, the control pendant 36″ is placed in selective communication with the first and second tables 12 and 14 through conventional wiring or, alternatively, through a wireless communication link of the type identified above with respect to FIGS. 4-7. Moreover, a first communication link 147 extends between the control pendant 36″ and an adapter 148, which may comprise a conventional “Y” adapter or connector. First and second table communication links 150a and 150b extend from the adapter to the first and second tables 12 and 14, respectively. Again, the first and second tables 12 and 14 may be connected to the control pendant 36 in parallel or, alternatively, in series in a manner similar to that identified above with respect to the embodiments of FIGS. 4-7.

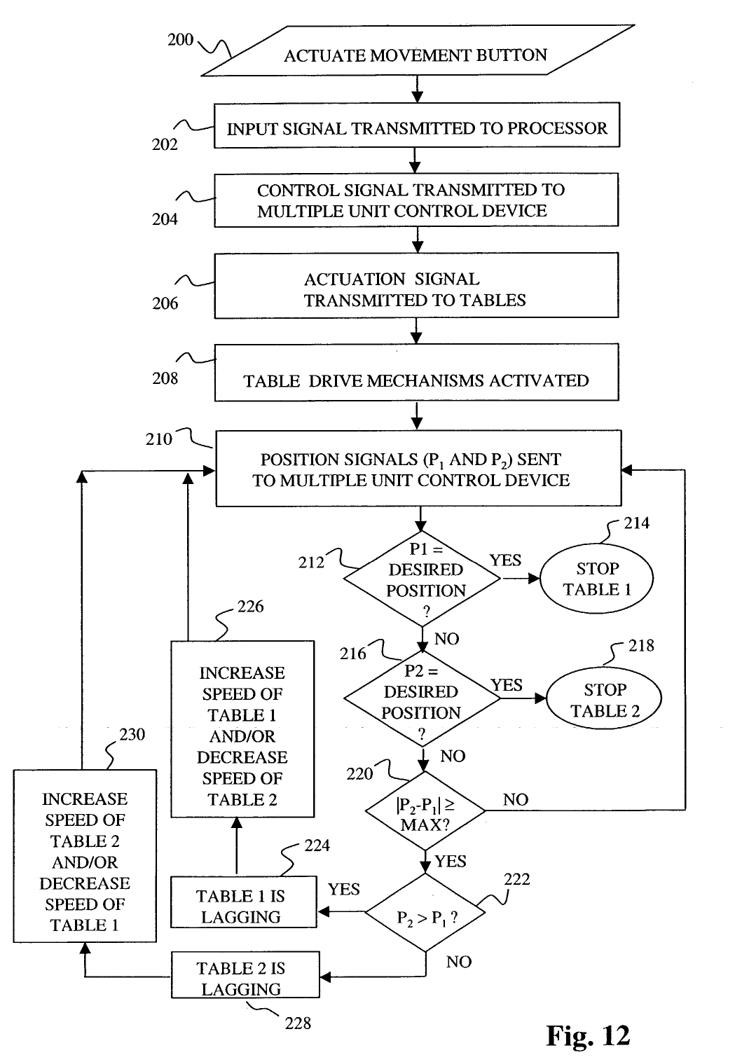

Turning now to FIG. 12, an illustrative method of operation of the present invention associated with the embodiments of FIGS. 1-7 begins at block 200 with the actuation of a movement button 37 on the control panel 63 of the pendant 36. Upon actuation of a button 37 on the control panel 63, at block 202, an input signal 131 is transmitted to the processor 130 which, in turn, transmits a control signal 132 to the multiple unit control device 134 at block 204. The multiple unit control device 134 transmits an actuation signal 133 to both the first and second tables 12 and 14 at block 206. As such, the first and second drive mechanisms 53a and 53b are actuated at block 208 to move the articulated frames 28a and 28b.

The process continues at block 210 where feedback position signals 135a and 135b of the first and second tables 12 and 14 are sent to the unit multiple unit control device 134. For illustrative purposes, positions of the first and second tables 12 and 14 represented by the position signals 135a and 135b from the first and second position sensors 129a and 129b are identified as P1 and P2 in FIG. 12. At block 212, the multiple unit control device 134 queries whether the first table position (P1) equals the desired position of the predetermined configuration. If so, then the first table 12 is stopped at block 214. If not, then the process continues to block 216 where the multiple unit control device 134 queries whether the second table position (P2) equals the desired position of the predetermined configuration. Again, if this query is answered in the positive, then the second table 14 is stopped at block 218. If the desired position is not reached, then the process continues to decision block 220.

At decision block 220, the absolute value of the difference between the first and second table positions (P1, P2) is compared to a maximum predefined value (MAX). If the absolute value of the difference of the positions exceeds or is equal to the maximum value then the process continues to block 222. If not, then the process returns to block 210.

At block 222, the multiple unit control device queries 134 whether the position (P2) of the second table 14 is greater than the position (P1) of the first table 12. If so, then the multiple unit control device 134 determines that the first table 12 is lagging behind the second table 14 at block 224. As such, at block 226, the speed of the first table 12 is increased and/or the speed of the second table 14 is decreased. If at block 222 it is determined that the position (P2) of the second table 14 is not greater than the position (P1) of the first table 12, then at block 228 the multiple unit control device 136 determines that the second table 14 is lagging behind the first table 12. As such, at block 230, the multiple unit control device 136 increases the speed of the second table 14 and/or decreases the speed of the first table 12. Then the process continues at block 210.

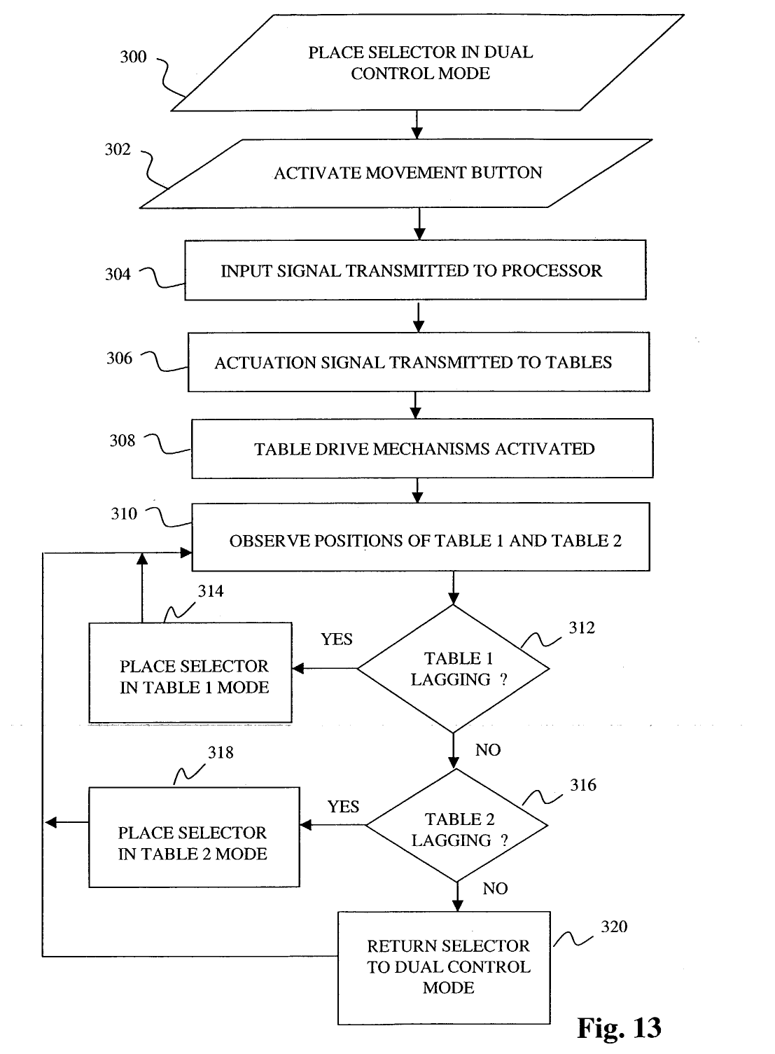

An alternative method of operation of the present invention associated with the embodiments of FIGS. 8-11 is illustrated in FIG. 13. At block 300, the selector 144 is placed in a dual control mode which, in turn, places both the first and second tables 12 and 14 in communication with the processor 130′. Next, the user actuates a movement button 37 on the control panel 63′ at block 302. An input signal 131 is transmitted to the microprocessor 130′ at block 304 which, in turn, causes actuation signals 133a, 133b to be transmitted through the adaptor 148 to both the first and second tables 12 and 14 at block 306. Next, the first and second drive mechanisms 53a, 53b are activated in response to the actuation signals 133a, 133b thereby causing the articulated frames 28a and 28b of both tables 12 and 14 to move at block 308.

The user visually observes the relative positions of the first and second tables 12 and 14 at block 310. If the operator determines that the first table 12 is lagging behind the second table 14 at block 312, then she places the selector 144 in a first table mode position at block 314. As such, only table 12 receives actuation signals 133a from the microprocessor 130. Continued movement of the first table 12 will cause the first table 12 to advance relative to the second table 14. The process continues at block 310 where user continues to observe the relative positions of the first and second tables 12 and 14 until it is determined that the first table 12 is no longer lagging.

Returning to block 312, if the first table 12 is not lagging, then the process continues to decision block 316 where the user determines whether the second table 14 is lagging behind the first table 12. If so, then the user places the selector 144 in the second table mode at block 318. As such, the processor 130 is only in communication with the second table 14 such that the actuation signal 133b is transmitted only to the second table 14 and causes movement of the second table 14 alone. The second table 14 will therefore advance relative to the first table 12. The user continues to observe the relative positions of the first and second tables 12 and 14 at block 310 until it is determined that the first table 12 is not lagging the second table 14 and that the second table 14 is not lagging first table 12. At this point, the process continues to block 320 where the operator returns the selector 144 to a dual mode control, if necessary.

In another embodiment, the apparatus may be connected to feedback sensors as discussed above. The processor 130′ automatically switches the modes of operation based on the position feedback signals 135. As such, the modes of operation are automatically selected without the need for manual manipulation of the selector 144 by the operator.

In yet another embodiment, control buttons similar to control buttons 37 detailed above are provided in communication with the mattresses 30a, 30b defining the patient support surfaces 16a, 16b. Moreover, the chambers in mattress sections 54a, 54b, 58a, 58b, and 60a, 60b may be simultaneously controlled in the manner detailed in U.S. Pat. No. 5,966,763 and U.S. patent application Ser. No. 09/951,577, filed Sep. 11, 2001, both of which are expressly incorporated by reference herein.

Although the invention has been described in detail with reference to certain preferred embodiments, variations and modifications exist within the spirit and scope of the invention as described and defined in the following claims.

What is claimed is:

1. A medical device control system for controlling a first patient support having a first articulated frame and a second patient support having a second articulated frame, the medical device control system comprising:
a user input device configured to generate an input signal in response to activation by a user;
a processor in communication with the user input device and configured to generate a control signal in response to the input signal; and
a multiple unit control device in communication with the processor and configured to simultaneously drive the first and second articulated frames to first and second desired frame configurations in response to the control signal, the multiple unit control device having a synchronization device configured to synchronize movement of the first and second articulated frames such that the first desired frame configuration is substantially the same as the second desired frame configuration.

2. The medical device control system of claim 1, wherein the first and second patient supports include position sensors configured to detect the frame configurations of the first and second articulated frames and further configured to generate position signals indicative thereof, and the multiple unit control device is configured to receive the position signals from the first and second patient supports.

3. The medical device control system of claim 1, further comprising a housing wherein the user input device includes a plurality of control buttons supported by the housing.

4. The medical device control system of claim 3, wherein each of the control buttons transmits an input signal corresponding to a desired preset frame configuration, and iconographic representations of frame configurations are associated with the plurality of control buttons.

5. The medical device control system of claim 1, wherein the first and second patient supports are connected in parallel to the multiple unit control device.

6. The medical device control system of claim 1, wherein the first and second patient supports are connected in series to the multiple unit control device.

7. The medical device control system of claim 1, further comprising a wireless link coupling the processor with the multiple unit control device.

8. The medical device control system of claim 1, further comprising a wireless link coupling the multiple unit control device with the first and second patient supports.

9. The medical device control system of claim 1, further comprising a housing including an interior chamber, the processor being supported within the interior chamber.

10. The medical device control system of claim 1, further comprising a housing including an interior chamber, the multiple unit control device being supported within the interior chamber.

11. The medical device control system of claim 1, further comprising a first mattress having a first patient support surface coupled to the first articulated frame and a second mattress having a second patient support surface coupled to the second articulated frame, the multiple unit control device being configured to simultaneously adjust the first and second patient support surfaces to first and second desired surface configurations.

12. The medical device control system of claim 11, wherein the first and second mattresses each comprise a plurality of inflatable fluid chambers.

13. A medical device control system for controlling a first patient support having a first articulated frame and a second patient support having a second articulated frame, the medical device control system comprising:
a housing;
a frame control input device coupled to the housing and configured to generate an input signal in response to activation by a user; and
a selector coupled to the housing and configured to be placed in any one of at least three modes of operation including a first mode of operation which places the input device in communication with the first patient support, a second mode of operation which places the input device in communication with the second patient support, and a third mode of operation which places the input device in communication with both the first patient support and the second patient support.

14. The medical device control system of claim 13, further comprising a processor in communication with the input device and configured to generate a control signal in response to the input signal.

15. The medical device control system of claim 13, wherein the selector is further configured to be placed in a fourth mode of operation which disconnects the input device from both the first and second patient supports.

16. The medical device control system of claim 13, wherein the selector comprises a rotary switch supported by the housing for rotation between at least three positions representing the at least three modes of operation.

17. The medical device control system of claim 13, wherein the selector comprises a push button switch supported by the housing and configured to alternate between the at least three modes of operation by depressing the button.

18. The medical device control system of claim 13, wherein the user input device comprises a plurality of control buttons supported by an outer wall of the housing.

19. The medical device control system of claim 13, wherein the first and second patient supports are connected in parallel to the multiple control device.

20. The medical device control system of claim 13, wherein the first and second patient supports are connected in series to the multiple control device.

21. A patient support apparatus comprising:
a first patient support including a first frame having a plurality of first frame sections movable relative to each other to position the first frame in a plurality of different frame configurations, and a first frame drive mechanism configured to drive the first frame in motion;
a second patient support table including a second frame having a plurality of second frame sections movable relative to each other to position the second frame in a plurality of different frame configurations, the second frame positioned longitudinally adjacent to the first frame, and a second frame drive mechanism configured to drive the second frame in motion; and
a controller coupled to both the first patient support and the second patient support and configured to activate simultaneously both the first frame drive mechanism and the second frame drive mechanism.

22. The patient support apparatus of claim 21, wherein the controller comprises a multiple unit control device configured to simultaneously drive the first and second articulated frames to first and second desired frame configurations, the multiple unit control device having a synchronization device configured to synchronize movement of the first and second articulated frames such that the first desired frame configuration is substantially the same as the second desired frame configuration.

23. The patient support apparatus of claim 22, wherein the first and second patient supports include position sensors configured to detect the frame configurations of the first and second articulated frames and to generate position signals indicative thereof, and the multiple unit control device is configured to receive the position signals from the first and second patient supports.

24. The patient support apparatus of claim 21, further comprising a user input device including a housing and a plurality of control buttons supported by the housing.

25. The patient support apparatus of claim 24, wherein each of the control buttons transmits an input signal to the controller corresponding to a desired preset frame configuration, and iconographic representations of frame configurations are associated with the plurality of control buttons.

26. The patient support apparatus of claim 22, wherein the first and second patient supports are connected in parallel to the multiple unit control device.

27. The patient support apparatus of claim 22, wherein the first and second patient supports are connected in series to the multiple unit control device.

28. The patient support apparatus of claim 21, further comprising a first mattress having a first patient support surface coupled to the first frame and a second mattress having a second patient support surface coupled to the second frame, the multiple unit control device being configured to simultaneously adjust the first and second patient support surfaces to first and second desired surface configurations.

29. The patient support apparatus of claim 28, wherein the first and second mattresses each comprise a plurality of inflatable fluid chambers.

30. A patient support system comprising:
a first articulated frame defining a first longitudinal axis;
a first frame drive operably coupled to the first articulated frame and configured to drive the first articulated frame in motion;
a second articulated frame defining a second longitudinal axis extending substantially parallel to the first longitudinal axis, the second articulated frame configured for articulating movement independently from the first articulated frame;
a second frame drive operably coupled to the second articulated frame and configured to drive the second articulated frame in motion;
a user input device operably connected to the first and second frame drives; and
a multiple unit control device in communication with the user input device and the first and second frame drives, the multiple unit control device configured to control simultaneous movement of the first and second articulated frames through first and second paths of travel to first and second desired frame configurations, the multiple unit control device having a synchronization device configured to synchronize movement of the first and second articulated frames such that the configurations of the first and second articulated frames are maintained substantially the same throughout the first and second paths of travel.

31. The patient support system of claim 30, further comprising first and second position sensors operably coupled to the first and second articulated frames, the first and second position sensors configured to detect the frame configurations of the first and second articulated frames and generate position signals indicative thereof, and the multiple unit control device is configured to receive the position signals from the first and second position sensors.

32. The patient support system of claim 30, further comprising a housing supporting the user input device, wherein the user input device includes a plurality of control buttons.

33. The patient support system of claim 32, wherein each of the control buttons transmits an input signal corresponding to a desired preset frame configuration, and iconographic representations of frame configurations are associated with the plurality of control buttons.

34. The patient support system of claim 30, wherein the first and second frame drives are connected in parallel to the multiple control device.

35. The patient support system of claim 30, wherein the first and second frame drives are connected in series to the multiple control device.

36. The patient support system of claim 30, further comprising a first mattress having a first patient support surface coupled to the first articulated frame and a second mattress having a second patient support surface coupled to the second articulated frame, the multiple unit control device configured to simultaneously adjust the first and second patient support surfaces to first and second desired surface configurations.

37. The patient support system of claim 36, wherein the first and second mattresses each comprise a plurality of inflatable fluid chambers.

38. A patient support system comprising:
a first articulated frame defining a first longitudinal axis;
a first frame drive coupled to the first articulated frame and configured to drive the first articulated frame in motion;
a second articulated frame defining a second longitudinal axis extending substantially parallel to the first longitudinal axis, the second articulated frame configured for articulating movement independently from the first articulated frame;
a second frame drive coupled to the second articulated frame and configured to drive the second articulated frame in motion;
a frame control input device operably coupled to the first and second frame drives and configured to generate an input signal; and
a selector in communication with the frame control input device and configured to be placed in any one of at least three modes of operation including a first mode of operation which places the input device in communication with the first frame drive, a second mode of operation which places the input device in communication with the second frame drive, and a third mode of operation which places the input device in communication with both the first frame drive and the second frame drive.

39. The patient support system of claim 38, further comprising a processor in communication with the input device for generating a control signal in response to the input signal.

40. The patient support system of claim 38, wherein the selector is further configured to be placed in a fourth mode of operation which disconnects the input device from both the first and second frame drives.

41. The patient support system of claim 38, wherein the selector comprises a switch supported by the housing for rotation between at least three positions representing the at least three modes of operation.

42. The patient support system of claim 38, wherein the selector comprises a push button supported by the housing and configured to alternate between the at least three modes of operation by depressing the button.

43. The patient support system of claim 38, wherein the frame control input device comprises a housing and a plurality of control buttons supported by the housing.

44. A method of moving first and second patient supports in substantially synchronized motion, the method comprising the steps of:
providing a first patient support including a first articulated frame, the first articulated frame including a plurality of movable sections and defining a first longitudinal axis;
providing a second patient support including a second articulated frame, the second articulated frame including a plurality of movable sections and defining a second longitudinal axis;
placing the first patient support and the second patient support proximate each other such that the first longitudinal axis is substantially parallel to the second longitudinal axis;
simultaneously driving in motion both the first articulated frame and the second articulated frame to first and second desired frame configurations; and
synchronizing movement of the first and second articulated frames such that the first desired frame configuration is substantially the same as the second desired frame configuration.

45. The method of claim 44, wherein the step of synchronizing movement comprises the steps of:
providing first position information from the first patient support indicative of the positioning of the plurality of movable sections of the first frame;
providing second position information from the second patient support indicative of the positioning of the plurality of movable sections of the second frame; comparing the first position information with the second position information; and
adjusting the relative positioning of at least one of the plurality of movable sections of the first and second frames in response to the first and second position information.

46. The method of claim 45, wherein the step of comparing the first position information with the second position information comprises the step of designating one of the first and second frames as a lagging frame and the other of the first and second frames as an advancing frame.

47. The method of claim 46, wherein the step of adjusting the relative positioning comprises the step of increasing the speed of the lagging frame.

48. The method of claim 46, wherein the step of adjusting the relative positioning comprises the step of decreasing the speed of the advancing frame.

49. A medical device control system for controlling a first patient support having a first articulated frame and a second patient support having a second articulated frame, the medical device control system comprising:
means for generating an input signal in response to activation by a user;
means for generating a control signal in response to the input signal; and
means for simultaneously driving the first and second articulated frames to first and second desired frame configurations in response to the control signal.

50. The medical device control system of claim 49, further comprising means for synchronizing movement of the first and second articulated frames such that the first desired frame configuration is substantially the same as the second desired frame configuration.
